(19) United States
(12) Patent Application Publication
(10) Pub. No.: US 2022/0351231 A1
(43) Pub. Date: Nov. 3, 2022

(54) Universal Loyalty Membership Platform

(71) Applicant: Bolt Financial, Inc., San Francisco, CA (US)

(72) Inventors: Emily Yeh, San Francisco, CA (US); Melvin Philips, Redwood City, CA (US); Gregory Richard Greiner, San Francisco, CA (US)

(21) Appl. No.: 17/246,519

(22) Filed: Apr. 30, 2021

(51) Int. Cl. G06Q 30/02; G06Q 30/06

(52) U.S. Cl. CPC G06Q 30/0229; G06Q 30/0635

(57) ABSTRACT

In one embodiment, a method includes receiving, by a transaction processing system, an order request from a buyer. The order request includes identifying information for the buyer and corresponds to a request for a transaction between the buyer and a seller. The method includes identifying membership program information for the buyer corresponding to a membership program associated with the seller and order preference information for the buyer based on querying a database associated with the transaction processing system using the identifying information for the buyer. The method includes causing an order placement user interface to be presented to the buyer, the order placement user interface comprising data stored in the membership program information. The method includes receiving an order placement request corresponding to the order request via the order placement user interface. The method includes updating the membership program information for the user based on the order placement request.

### TECHNICAL FIELD

This disclosure generally relates to merchant membership programs in sales transactions.

### BACKGROUND

Many online purchases are made by customers through independent merchants. In most cases, merchants allow customers to either register for an account with the merchant or to proceed with a purchase as a “guest.” Customers who register for accounts with a merchant often receive benefits, such as expedited re-ordering or subsequent ordering because the merchant can store necessary purchase information or easy access to an order history. Customers who make purchases as a guest must re-enter information such as shipping and payment information for each order. However, customers may prefer not to make additional accounts as they do not wish to be responsible for remembering an additional account name and password for each merchant from which they make purchases. This added burden discourages customers from taking advantage of the benefits offered by merchant-specific accounts and increases the friction and computing resources typically necessary to complete each subsequent customer order.

To encourage customers to create a merchant accounts, and to encourage customers to return to the merchant for future transactions, merchant can offer a membership program to their customers. The membership program, which often take the form of a loyalty program, can entitle the customer to benefits, such as advanced information, extra discounts, or unique features. However, membership programs must typically either be custom-made by the merchant, at great expense, or are provided through vendors that restrict the ability to customize the nature of benefits programs. Establishing membership programs and integrating the membership programs with existing merchant systems and vendor-provided systems can be a difficult and time-consuming task, especially for small merchants without access to advanced technical resources.

### SUMMARY OF PARTICULAR EMBODIMENTS

Embodiments described herein in include systems and method for managing, by a transaction processing system, a membership platform on behalf of a variety of sellers that use the transaction processing system. The membership platform can dictate the availability and use various membership program benefits made available by the transaction processing system and the sellers. In particular, the membership platform can provide for the availability of membership programs that are maintained by the membership platform on behalf of sellers such that a customer of the sellers can join a membership program to access benefits from multiple sellers who may otherwise be unrelated. The membership platform can reduce the number of distinct membership programs (e.g., each associated with an individual seller) into which a customer must enter, while expanding access to and availability of membership programs to customers on behalf of sellers. In particular embodiments, a transaction processing system receives an order request from a buyer. The order request includes identifying information for the buyer and corresponds to a request for a transaction between the buyer and a seller. The transaction processing system identifies membership program information for the buyer corresponding to a membership program associated with the seller and order preference information for the buyer based on querying a database associated with the transaction processing system using the identifying information for the buyer. The transaction processing system causes an order placement user interface to be presented to the buyer, the order placement user interface preloaded with data stored in the membership program information. The transaction processing system receives an order placement request corresponding to the order request via the order placement user interface. The transaction processing system updates the membership program information for the user based on the order placement request.

The embodiments disclosed above are only examples, and the scope of this disclosure is not limited to them. Particular embodiments may include all, some, or none of the components, elements, features, functions, operations, or steps of the embodiments disclosed above.

### BRIEF DESCRIPTION OF THE DRAWINGS

FIG. 1 illustrates an example method for creating a membership program.

FIG. 2 illustrates an example method using a membership program offered by a transaction processing system through a membership platform.

FIG. 3 illustrates example interactions between components of a transaction processing system.

FIGS. 4A-4C illustrate example user interfaces involving the membership platform.

FIGS. 5A-5C illustrate example user interfaces involving the membership platform.

FIG. 6 illustrates physical architecture of a transaction processing system platform.

FIG. 7 illustrates an alternate visualization of the platform.

FIG. 8 illustrates transaction processing system platform connections with third party ecommerce platforms.

FIG. 9 illustrates information flows between the transaction processing system platform and a third party platform.

FIG. 10 illustrates the lifecycle of a purchase order.

FIG. 11 illustrates an example computer system.

### DESCRIPTION OF EXAMPLE EMBODIMENTS

Particular embodiments disclosed herein may be designed to address specific problems or omissions in the current state of the art as described herein. As described herein, particular embodiments include systems and method for managing, by a transaction processing system, a membership platform on behalf of a variety of sellers that use the transaction processing system. The membership platform can dictate the availability and use various membership program benefits made available by the transaction processing system and the sellers. In particular embodiments, a transaction processing system receives an order request from a buyer. The order request includes identifying information for the buyer and corresponds to a request for a transaction between the buyer and a seller. The transaction processing system identifies membership program information for the buyer corresponding to a membership program associated with the seller and order preference information for the buyer based on querying a database associated with the transaction processing system using the identifying information for the buyer. The transaction processing system causes an order placement user interface to be presented to the buyer, the order placement user interface preloaded with data stored in the membership program information. The transaction processing system receives an order placement request corresponding to the order request via the order placement user interface. The transaction processing system updates the membership program information for the user based on the order placement request. In particular embodiments, the order preference information includes payment information and shipping information stored by the transaction processing system on behalf of the buyer. In particular embodiments, the order request is received from a seller computing device. In particular embodiments, the order request is received from a user device associated with the buyer.

In particular embodiments, the transaction processing system determines, based on the membership program information for the buyer, that the buyer does not have a pre-existing relationship with the seller. In particular embodiments, updating the membership program information for the user based on the order placement request includes enrolling the buyer in the membership program. In particular embodiments, the membership program is associated with an affiliated group of sellers that includes the seller. The membership program information is based on a pre-existing relationship with the affiliated group of sellers. In particular embodiments, the membership program corresponds to an affiliated group of sellers including the seller, and wherein the membership program information is associated with a pre-existing relationship with another seller of the affiliated group of sellers. In particular embodiments, generating the membership program information for the buyer by includes accessing a record of transactions conducted by the buyer with the seller, accessing a record of transactions conducted by the buyer with the other seller of the affiliated group of sellers using the transaction processing system, and merging the record of transactions conducted by the buyer with the seller and the record of transactions conducted by the buyer with the other seller of the affiliated group of sellers. In particular embodiments, the transaction processing system determines that the buyer is eligible for a discount to be applied to the transaction between the buyer and the seller by accessing a database associated with the seller based on the membership program information for the buyer, retrieving a set of discounts associated with the membership program available for the buyer from the database associated with the seller, where one or more discounts of the set of discounts are associated with a restriction, and determining that the transaction between the buyer and the seller satisfies the restriction associated with a first discount of the set of discounts based on at least the membership program information for the buyer. The transaction processing system applies the first discount to the transaction. In particular embodiments, the discount is applied responsive to a selection of the discount by the buyer. In particular embodiments, after applying the discount to the transaction, the transaction processing system updates the database associated with the seller to indicate that the buyer has used the first discount.

In particular embodiments, the transaction processing system identifies one or more membership benefits corresponding to the membership program. The transaction processing system determines that the buyer is eligible for a first membership benefit of the one or more membership benefits based on at least the membership program information for the buyer. The transaction processing system applies the first membership benefit to the transaction between the buyer and the seller. In particular embodiments, the record of transactions conducted by the buyer with the seller is received from a merchant system associated with the seller. In particular embodiments, the membership program includes a number of benefit tiers, each tier being associated with a set of membership benefits. The membership program information for the buyer identifies a first benefit tier of the number of benefit tiers and updating the membership program information for the user based on the order placement request includes modifying the membership program information for the buyer to identify a second benefit tier of the number of benefit tiers.

In particular embodiments, a transaction processing system establishes the membership program on behalf of a seller on the membership platform. The transaction processing system receives a request from a seller to create the membership program for the seller. The seller may have conducted transactions with buyers using the transaction processing system. The transaction processing system accesses a record of the transactions in a database associated with the transaction processing system. The transaction processing system also accesses a user account record for each buyer from the database associated with the transaction processing system. The user account record for each buyer includes a respective user identifier for the buyer. The transaction processing system creates membership program information for each buyer using the record of the transactions. The transaction processing system stores, in the database associated with the transaction processing system, the membership program information for each buyer in association with a respective user identifier for the buyer and the user account record for the buyer. In particular embodiments, the request identifies one or more other sellers to associate with the membership program for the seller. The transaction processing system accesses a respective record of transactions conducted by the one or more other sellers using the transaction processing system. The transaction processing system updates the membership program information of the buyers based on the respective record of transactions conducted by the one or more other sellers. In particular embodiments, the transaction processing system receives a checkout request for a transaction between the seller and a buyer that includes a user identifier for the buyer. The transaction processing system retrieves the membership program information for the buyer from the database associated with the transaction processing system based on the user identifier. The transaction processing system updates the membership program information for the buyer based on the checkout request for the transaction. In particular embodiments, prior to requesting to create the membership program, the seller has a pre-existing membership program, not associated with the transaction processing system. The seller discontinues the pre-existing membership program after sending the request to create the membership program.

Many online purchases are made by customers through independent merchants. In most cases, merchants allow customers to either register for an account with the merchant or to proceed with a purchase as a “guest.” Customers who register for accounts with a merchant often receive benefits, such as expedited re-ordering or subsequent ordering because the merchant can store necessary purchase information or easy access to an order history. Customers who make purchases as a guest must re-enter information such as shipping and payment information for each order. However, customers may prefer not to make additional accounts as they do not wish to be responsible for remembering an additional account name and password for each merchant from which they make purchases. This added burden discourages customers from taking advantage of the benefits offered by merchant-specific accounts and increases the friction and computing resources typically necessary to complete each subsequent customer order.

To encourage customers to create a merchant accounts, and to encourage customers to return to the merchant for future transactions, merchant can offer a membership program to their customers. The membership program, which often take the form of a loyalty program, can entitle the customer to benefits, such as advanced information, extra discounts, or unique features. However, membership programs must typically either be custom-made by the merchant, at great expense, or are provided through vendors that restrict the ability to customize the nature of benefits programs. Establishing membership programs and integrating the membership programs with existing merchant systems and vendor-provided systems can be a difficult and time-consuming task, especially for small merchants without access to advanced technical resources.

Accordingly, it has been determined that it is beneficial to sellers for a transaction processing system to provide a platform through which sellers can easily customize the appearance and experience of membership platforms. Furthermore, because the transaction processing system can naturally have access to the seller's transactions, the transaction processing system can greatly increase the convenience of the seller's customers in using the membership program. Particular embodiments disclosed herein may provide one or more of the results, effects, or benefits described herein.

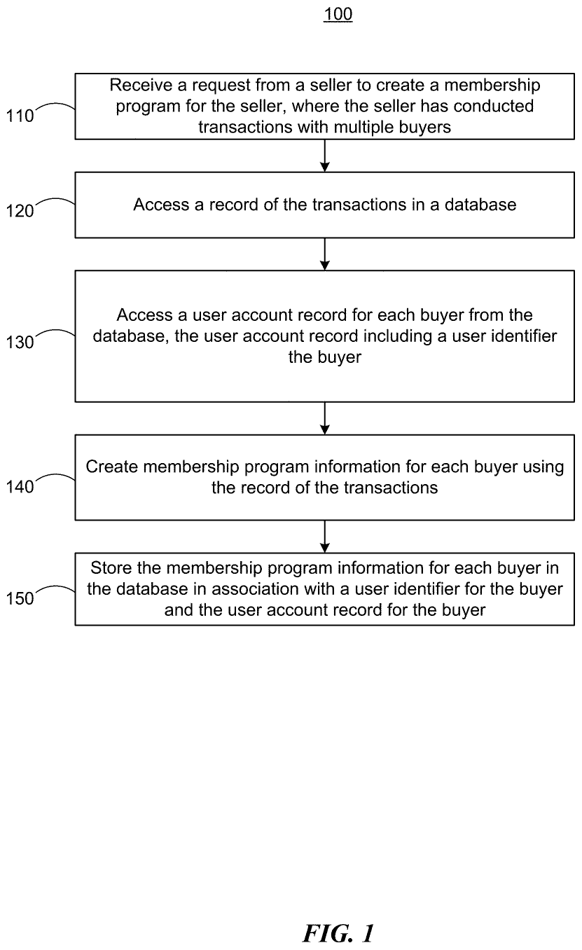

In particular embodiments, the transaction processing system creates a membership program on behalf of a seller within the membership platform. FIG. 1 illustrates an example method 100 for creating a membership program on behalf of the seller.

At step 110, the transaction processing system receives a request from a seller to create a membership program for the seller. As an example, the seller may operate a pre-existing membership program, not associated with the transaction processing system. The pre-existing membership program may be operated by the seller or by a third-party vendor of the seller. The seller, desiring to access the benefits of the membership platform, as described herein, contacts the transaction processing system to request a membership program. In some embodiments, the request can be automated via, for example, one or more application programming interfaces (API). The transaction processing system can provide a dashboard to sellers for managing the sellers' accounts with the transaction processing system. The dashboard can be provided, for example, through a website associated with the transaction processing system, a native application associated with the transaction processing system, etc. The dashboard can be used to manage all aspects of the sellers' accounts, including access to the membership platform. The seller can provide identifying information for the seller, such as information to identify the account of the seller on the transaction processing system, if available. If it is not available, the seller can create an account. In particular embodiments, it may be preferred for sellers to have existing accounts because, as described herein, it may simplify the onboarding and data ingesting process executed by the transaction processing system. It is envisioned that, after the seller creates a membership program using the membership platform operated by the transaction processing system, the seller may discontinue the use of any pre-existing membership programs to avoid buyer confusion as well as the added cost of maintaining redundant programs unnecessarily.

The membership program can be used to provide a variety of benefits to both buyers and sellers. For example, the membership program may support the provisioning of discounts to be applied to pending transactions between buyers and the seller. Through the transaction processing system, the seller can manage access to the discounts based on a history of interactions between a potential buyer and the seller according to the goals of the seller. For example, the seller can specify that repeat customers be provided a slight discount on their overall total or that customers who have a pending transaction above a specified amount can receive free or upgraded shipping. Discounts can also be specified to types of items or even individual items. The membership platform simplifies and streamlines the requirements for managing discounts such as these. Furthermore, the transaction processing system can reduce the amount of time required to process transactions, and in particular, to calculate the availability and applicability of discounts because the transaction processing system can perform all of the calculations without calling out to additional systems. Additionally, the transaction processing system can track a buyer's shopping cart and actively determine the applicability of discounts offered by the seller according to the membership program in advance of the buyer checking out.

Another feature offered by the membership platform to buyers is the use of benefit tiers. As used herein, benefit tiers refers to the creation and maintenance of multiple levels within the membership program. As the buyer unlocks higher tiers of the membership program, the buyer gains access to more and feature benefits offered by the seller. As with discounts, the transaction processing system can simplify the processes of specifying benefit tiers and associated benefits. The transaction processing system can further identify and apply the corresponding benefits for buyers in later transactions or other interactions between the buyer and seller (e.g., managing the sellers account with the buyer) automatically without the buyer tracking their qualifications for different tiers. The tiers can be locked for example, based on the buyer's transaction history with the seller. The transaction processing system can interrogate the buyer's transaction history with the seller to determine, for example, the number of purchases made, the number of items purchased, the variety of items purchased, the mode of making the purchase (e.g., mobile vs. desktop), the total amount spent, the number of transactions conducted above a threshold amounts, etc. The seller can specify that membership benefit levels correspond to advancing levels of any of these parameters as or a combination of one or more of the parameters. For example, the seller can specify that the highest level of the membership program is restricted to buyers who have spent $200 on purchases in the last calendar year or have made five purchases of $150 or more overall.

A third category of features that may be offered by the membership platform, and may be selectively enabled by the seller, are points-based rewards. For example, the seller can specify that certain actions, such as purchases, amount spent, number of distinct items purchased, etc., are associated with points values. A buyer can accrue points, which may be tracked by the transaction processing system. The buyer can spend the points to unlock certain benefits or discounts. For example, a buyer can use a collection of points to unlock free shipping or a 10% discount for an order. By using the membership platform, the seller can easily customize the features offered by the membership platform through a single unified interface. Additionally, the features can be enhanced when the seller uses the transaction processing system to handle multiple aspects of their transaction processing.

As described, the seller may have an account with the transaction processing system and may have conducted transactions with a variety of different buyers using the transaction processing system. The transaction processing system can create records of these transactions and store the records in one or more database systems maintained by the transaction processing system. The transaction processing system can use the records for analysis that provides insight to the seller. If the seller has an active account prior to requesting the creation of a membership program using the membership platform, the transaction processing system can streamline enrolling buyers in the membership program offered by the seller once approval to enter the membership program is received.

At step 120, in particular embodiments, the transaction processing system may access a record of the transactions for the purposes of enrolling existing customers of the seller in the membership program. Customer enrollment into a membership program may be conditioned on express acknowledgement or consent from the customer. Where the seller has an active account with the transaction processing system, the records can be access by simply identifying transactions the database associated with the seller. In other embodiments, the seller may not have had an account prior to requesting to create the membership program. Additionally, the seller may have their own transaction records which they would like to present to the transaction processing system. The seller can direct the transaction processing system to access a merchant system associated with the seller to retrieve the record of the transactions. For example, the transaction processing system can provide multiple methods of uploading or otherwise presenting these records of transactions. The transaction processing system can provide a simple interface, e.g., through a website, to upload files containing the seller's records. The transaction processing system can provide further interfaces that may be configurable to be accessed by the seller's merchant system. As another example, the seller's merchant system can provide a programming interface to allow for mass upload access or access to individual transaction record queries. The transaction processing system can receive a specification of the programming interface from the seller and attempt to retrieve the records.

At step 130, in particular embodiments, the transaction processing system may also access a user account record for each buyer that is represented in the seller's transaction history. For example, the transaction processing system may maintain user account records for buyers who have created an account with the transaction processing system. As described herein, the account allows the buyer to quickly and easily confirm a checkout procedure with merchants who use the transaction processing system. In certain embodiments, the account may be indexed according to a unique user identifier. The transaction processing system can attempt to correlate the user account records with the buyer information from the seller. For example, the transaction processing system can compare information in its user account records to information in the records from the seller. The transaction processing system can query the records from the seller for user identifiers that have a match in the user account records database of the transaction processing system. Upon finding matches, the transaction processing system can attempt to verify the correlation by looking to additional pieces of data. For example, the user account record can include multiple user identifiers (e.g., an email address and a phone number) that can be matched to the records from the seller. As another example, the transaction processing system can match information such as shipping address or payment information that is likely to be unique to individual buyers.

At step 140, in particular embodiments, the transaction processing system creates membership program information for each buyer that has conducted a transaction with the seller (and optionally, that can be verified as having a corresponding user account record) using the record of transactions from the data or the seller. Where the buyer did not appear to have a corresponding account, the transaction processing system may create a new user account record for the buyer and store membership information with it. Where the buyer has an account, the transaction processing system can update any account information membership program information. The membership program information can include, for example, the user's transaction history with the seller or analyses and metrics derived from the user's transaction history (e.g., the number of transactions, the date of last transaction, the total amount spent, etc.). The membership program information can also include the buyer's status in the membership program offered by the seller. This can include, for example, the discounts available to buyer, the points accrued by the buyer, or the benefit tier level of the user.

In particular embodiments, the request to create a membership program may identify one or more other sellers to associate with the membership program for the seller. As an example, using the above-describe dashboard for managing the account of the seller with the transaction processing system, including their membership program, the seller can enter identifying information for another seller and request the creation of a membership program with the other seller. The identifying information can include information regarding the name of the seller, contact information for a representative of the other seller, contact information for the account of the seller with the transaction processing system, etc. For example, the seller can join with other sellers to create a multi-merchant loyalty program. Through such a program, buyers can access the benefits of a membership program based on activity with more than one seller. The sellers in turn can share information about buyers and encourage the buyers to visit other members of the program. Such an affiliated group of sellers can be adjusted dynamically as sellers gain and lose interest in the shared benefits program (e.g., through the above-reference dashboard). In particular embodiments enrollment in the membership program may be at no cost to buyers. In other embodiments, buyers may pay to access the program and/or access premium features (e.g., expedited shipping) available only to premium members.

Before creating the association between sellers within a membership program, the transaction processing system can confirm consent from all sellers to create the multi-seller membership program. In particular embodiments, creating the affiliated group of merchants can require the specification of additional terms for the membership based on, for example, preferred vendors for the individual merchant(s) and for the membership program overall. For example, prior to joining the multi-merchant membership program, a merchant may use a first payment processor. Other merchants in the program may use a second payment processor. The membership program may itself be affiliated with the second payment processor for transactions conducted that use the membership program or the benefits of the membership program. As an example, the membership program may include, as a benefit, guaranteed insurance for purchases. The insurance may be provided through the second payment processor. The merchant joining the membership program may opt to change to the second payment processor for all transactions, transactions conducted through the membership program, or to allow for only a subset of items in orders to be purchased through the second payment processor.

If the seller requests the creation of a multi-merchant program, the transaction processing system may access a respective record of transactions conducted by the other sellers using the transaction processing system. The transaction processing system may update the membership program information of the buyers based on the respective record of transactions conducted by the one or more other sellers. In effect, the transaction processing system merges the records of transactions for the various sellers of the affiliated group of sellers for analysis, presentation, and/or use to create membership program information. The transaction processing system may also perform these steps after the membership program has been established for the seller, for example, if the seller determines they would like to join an affiliated group of sellers after initially setting up their program.

At step 150, in particular embodiments, the transaction processing system may store the membership program information for each buyer in association with a respective user identifier for the buyer and the user account record for the buyer in the database associated with the transaction processing system.

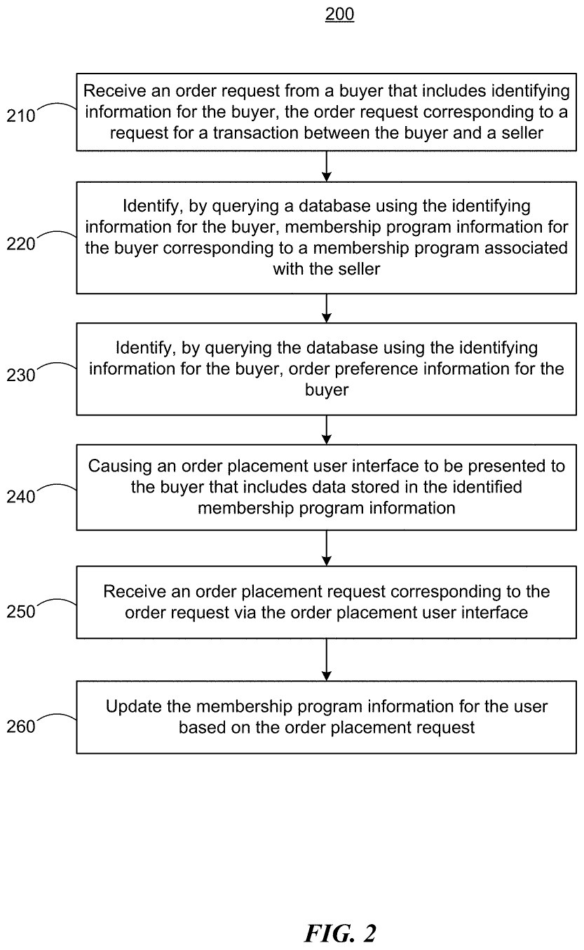

FIG. 2 illustrates an example method 200 using a membership program offered by a transaction processing system through a membership platform. In particular embodiments, after the transaction processing system creates the membership program and generates membership program information for members of the program (e.g., buyers who have conducted transactions with the seller on the transaction processing system), at step 210 the transaction processing system may receive an order request from a buyer for a transaction between the buyer and the seller. The order request may include identifying information for the buyer. As an example, the order request may be a checkout request received from a computing device associated with the seller. The seller can be identified form the checkout request by the transaction processing system mapping the computing device associated with the seller to the seller's account and membership program. In particular embodiments, the order request may also be received from a user device associated with the buyer and affirmatively identify the seller. In particular embodiments, the order request can include a user identifier or other identifying information (e.g., device identifier) for the buyer. The buyer may have entered an email address on the website of the seller before or during their visit to the website of the seller. The seller may provide this email address to the buyer. Furthermore, the transaction processing system may provide an integrated checkout interface for use by the seller. The integrated checkout interface can request the seller to enter their email address, phone number, or other identifying information so that the buyer can receive order updates and/or access an account with the transaction processing system. As described herein, an active account with the transaction processing system allows the buyer to quickly and securely complete checkout processes.

At step 220, in particular embodiments, the transaction processing system may identify membership program information for the buyer corresponding to the membership program associated with the seller by querying a database associated with or maintained by the transaction processing system using the identifying information for the buyer. At step 230, the transaction processing system may also identify order preference information for the buyer based on querying the same or another database associated with the transaction processing system using the identifying information for the buyer. As described above, the transaction processing system may use the identifying information as an index or key value for the account record of the user. This simplifies retrieval of the relevant information and ensures that the key values are unique because the identifying information may be guaranteed unique by the transaction processing system. The use of the identifying information also simplifies the process of determining whether or not the buyer has an existing relationship with the seller or with the transaction processing system. For example, if the transaction processing system is unable to identify membership program information for the buyer associated with the membership program of the seller, the transaction processing system can conclude that the buyer does not have an existing relationship with the seller because the seller does not have a record of transactions with the buyer from which to generate the membership program information. Similarly, if the transaction processing system is unable to identify order preference information for the buyer based on the identifying information for the buyer, the transaction processing system can conclude that the buyer either has not engaged with the transaction processing system before or has chosen not to create an account.

As described above, the membership program may not be limited to a single seller. In particular embodiments, the membership program may be associated with an affiliated group of sellers that includes the seller. Even in cases where the buyer does not have a pre-existing relationship with the seller (e.g., where the buyer has not made purchases from the seller before), the membership program information retrieved by the transaction processing system for the buyer can be based on a pre-existing relationship with the affiliated group of sellers or with an individual seller of the affiliated group of sellers. In particular embodiments, the affiliated group of sellers can be treated as a standalone entity for the purposes of managing membership program benefits. This may be especially beneficial in embodiments where the membership program has uniform benefits across all sellers in the affiliate group of sellers. This can include, for example, a membership program across a group of store brands owned by a single parent company, or a membership program in which enrolled buyers pay a fee to access free, expedited shipping or early access to limited sales events, etc.

At step 240, in particular embodiments, the transaction processing system may cause an order placement user interface to be presented to the buyer, for example on a user device of the buyer. The order placement interface may include, for example a checkout interface presented on the user device through which the buyer confirms the details of an order and selects, for example, payment and shipping details. The order placement interface can include a secured interface presented by the transaction processing system and which limits communication back to the merchant system of the seller. The transaction processing system may cause the order placement user interface to be preloaded with data stored in the membership program information and/or the order preference information. For example, the order preference information may include preferred payment information (e.g., a preferred payment card, virtual wallet, currency, etc.) and shipping information (e.g., shipping address, shipping speed, etc.).

In particular embodiments, prior to displaying the order placement user interface, the transaction processing system can also require the buyer to log in to their account. The transaction processing system can cause an account authentication interface to be presented on the user device of the buyer. The transaction processing system can receive a password entered by the buyer into one or more interface elements of the account authentication user interface and compare the received password with a stored password for the buyer's account to determine a correspondence between the two. In particular embodiments, the transaction processing system can support a one-time password login scheme, in which the buyer is sent a password via a communication channel associated with a verified user identifier (e.g., a email or short message service (SMS) message). The buyer enters the received password into the account authentication interface and the transaction processing system compares the received password with the sent password to determine a correspondence between granted access to sensitive account information.

As described herein, in particular embodiments, the membership program may include redeemable benefits for the buyer. These redeemable benefits may include one-time use or multi-use discounts for the buyer to apply to a transaction with the seller (or an affiliated seller if the sellers have opted in to such a benefit). The discounts may be associated with restrictions on their use, for example, a number of times an individual discount can be used by the buyer or overall, a number or value of items in a transaction required to access the discount, a restriction on types of items, a geographic location associated with the delivery or sale of the item, or similar or any combination thereof. Furthermore, the redeemable benefits may take the form of a points-based benefit system, wherein the buyer can redeem points to access certain discounts.

The transaction processing system may determine of the buyer is eligible to apply a discount to the pending transaction with the seller. In particular embodiments, the transaction processing system may access a database associated with the seller based on the membership program information for the buyer. The seller may maintain a database separate from the transaction processing system as a means of directly controlling how discounts are allocated. This leaves the transaction processing system responsible for applying valid discounts correctly. The seller can decide to remain the final point of truth for discounts that the seller will accept. A merchant system of the seller can provide a programming interface through which the transaction processing system can specify details of an order and/or the membership program information of the buyer. The transaction processing system may retrieve a set of discounts associated with the membership program available for the buyer. The transaction processing system may also retrieve any restrictions on the use of the discounts. The transaction processing system may determine that the pending transaction between the buyer and the seller satisfies the restriction associated with a first discount of the set of discounts based on at least the membership program information for the buyer. For example, a coupon offering 15% off of an entire order can have the restriction of being activated by a specified date and for transactions above a threshold dollar amount. The transaction processing system can compare the date of the transaction to specified date and compare the value of the proposed transaction to the threshold amount before determining that the seller is eligible to use the transaction processing system. As another example, a discount may be offered only for first time buyers that do not have an account with the seller or for buyers that have not placed an order in two weeks. The transaction processing system can analyze the membership program information for the buyer and additionally a transaction history of the buyer in evaluating whether the buyer satisfies the restrictions of the discount.

In particular embodiments, the transaction processing system may automatically apply an eligible discount to the transaction. Where the buyer is only eligible for a single discount, the transaction processing system can anticipate that the buyer will want to use that discount. The transaction processing system can also calculate which discount to use based on, for example, the total amount saved, the potential value of the discount compared to the potential value of the discount if used on a different transaction, an expiration date of the discount, other similar factors, or any combination thereof.

In particular embodiments, the buyer may be empowered to select which discount is to be applied to the pending transaction. For example, the transaction processing system can send information to the order placement user interface indicating which discounts are available, the details of the discounts, and possibly provide a recommendation based on the above-described factors or other factors selected by the buyer. The user device of the buyer may receive input corresponding to a discount and send a request to the transaction processing system to use that discount for the pending transaction. The transaction processing system may update the order placement user interface based on the discount, such as by showing a reduced final price, reduced shipping cost, etc. If the buyer uses a given discount for the pending transaction, the transaction processing system may update its records to reflect the use of the discount and may inform the seller that the buyer used the discount. For example, the transaction processing system may issue a message to a merchant system of the seller indicating that the buyer used the discount.

In addition to discounts, the membership program may be associated with identifying one or more additional membership benefits that can be applied to a transaction. These other membership benefits can have their own similar access restrictions that may be validated by the transaction processing system before they are used. Example additional benefits can include, but are not limited to, free, reduced, or upgraded shipping for all order placed by the buyer, enhanced post-purchase support and customer support, the ability to purchase certain types of items (e.g., customized items), access to special events such as unique sales or limited-access items, early access to new products, free returns, exclusive samples or gifts provided by sellers to buyers, access to exclusive content, including digital content, that is relevant to products offered by the seller (e.g., training videos, ideas for how to use products, etc.), and other related benefits. The transaction processing system can determine that the buyer is eligible for a first membership benefit of the one or more membership benefits based on at least the membership program information for the buyer and apply the first membership benefit to the transaction between the buyer and the seller. For example, the transaction processing system can identify a benefit level achieved by the buyer and stored in the membership information. The transaction processing system can also determine the membership level dynamically while preparing or presenting the order placement user interface.

At step 250, in particular embodiments, the transaction processing system can receive an order placement request corresponding to the order request via the order placement user interface. The order placement request can be a confirmation that buyer has agreed to the transaction and can further correspond to a command to the transaction processing system to begin processing the transaction. The transaction processing system can process payment information received with or subsequent to the order placement request to transfer funds from the buyer to the seller. In particular embodiments, the transaction processing system can provide the payment information to a preferred payment processor of the seller. The transaction processing system can also send the details of the transaction to the seller in order to allow the seller to begin to fulfill the order.

At step 260, in particular embodiments, the transaction processing system can update the membership program information for the user based on the order placement request. In certain embodiments, the transaction processing system can update any metrics used in determining availability for discount or benefits (e.g., number of transactions, recency of transactions, total amount spent, etc.). The transaction processing system can also update a transaction history keeping record of transactions between the buyer and seller.

As described herein, the membership program can include a number of benefit tiers that may be available to buyers based on meeting certain qualifications. As a buyer satisfies those qualifications, the buyer can unlock additional perks or benefits. The transaction processing system can calculate the buyer's progress towards unlocking the next tier of benefits and, if applicable, automatically upgrade the user to the next benefit tier for future transactions based on the order placement request. For example, if the buyer has completed an amount spent requirement, the total from the transaction represented by the order placement request can be added and compared against the benefit tier requirement. If the buyer satisfies the requirement, they can be notified that the new tier is available and be further notified of the benefits of the tier. In particular embodiments, the transaction processing system can instead store the information relevant for determining benefit tier status. The transaction processing system may calculate the benefit tier as order requests are received.

In particular embodiments, the buyer may not have a pre-existing relationship with the seller (e.g., prior to the just-completed transaction) and, in particular, may not have an existing membership program account with the seller's membership program. The transaction processing system may determine this by attempting to query the relevant database or database values and being unable to identify relevant records. In such a case, updating the membership program information for the user can include enrolling the buyer in the membership program by creating appropriate membership program information and storing it in association with the user data record for the buyer and identifying information for the buyer.

Particular embodiments may repeat one or more steps of the example process(es), where appropriate. Although this disclosure describes and illustrates particular steps of the example process(es) as occurring in a particular order, this disclosure contemplates any suitable steps of the example process(es) occurring in any suitable order. Moreover, although this disclosure describes and illustrates an example process, this disclosure contemplates any suitable process including any suitable steps, which may include all, some, or none of the steps of the example process(es), where appropriate. Furthermore, although this disclosure describes and illustrates particular components, devices, or systems carrying out particular steps of the example process(es), this disclosure contemplates any suitable combination of any suitable components, devices, or systems carrying out any suitable steps of the example process(es).

In particular embodiments, the membership platform offered by the transaction processing system can provide extensions to third-parties, such as participating merchants that enable additional features to be added to membership programs. These extensions (which may also be organized through the merchant dashboard or through appropriate API calls) can be added on a modular basis as the merchant determines which features they would like to add. For example, the merchant may use regular occurring seasonal discounts that they advertise to customer. The transaction processing system may facilitate automating this process by scheduling announcements for the discounts to be provided to customer through, e.g., third-parties providing SMS or email marketing services. The merchant may also have their own marketing services which can be exposed to the membership platform to allow the membership platform to serve as the central hub. In particular embodiments, the merchant can provide for highly personalized display of discounts to shoppers. For example, discounts can be provided only for items recommended to the shopper or discounts can be recommended based on the shopper's shopping history.

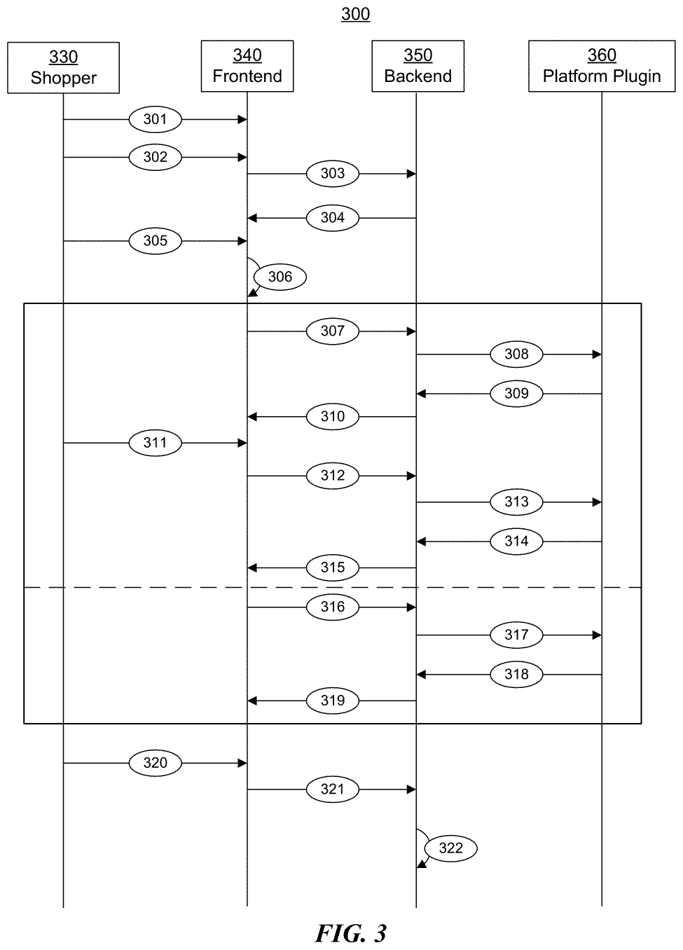

FIG. 3 illustrates example interactions between components of the transaction processing system and user devices. In particular, FIG. 3 illustrates a process 300 through which a shopper who is not a current member of a membership program can elect to join the membership program during a checkout procedure. The process 300 can begin at 301, where a shopper 330 elects to being a checkout process with the transaction processing system. For example, the shopper 330 may have been presented a user interface of a user device that includes a number of interactive elements corresponding to different payment types or checkout processing flows, the transaction processing system being one of those flow. In other embodiments, the transaction processing system may be the only processing system for a merchant, so a user interacting with a checkout element may automatically begin the process. A transaction processing system frontend 340 may be executing, e.g., on a user device of the shopper 330. The frontend may be executing in a website via a web browser, native application, or other suitable application of the user device. Upon receiving the notification at 301, the frontend may transition to a user interface including a number of user interface elements to collect user identifying information, such as a shopper email or phone number. The shopper 330 may enter user identifying information of their choice at 320.

After collecting the user identifying information, at 303, the transaction processing system frontend 340 sends a request to the transaction processing system backend 350 requesting a membership status of the shopper 330 based on the received user identifying information. The transaction processing system backend 350 may determine the membership status associated with user identifying information. For example, the transaction processing system may query a database of the transaction processing system to identify whether the user identifying information is associated with a valid account and, if so, whether that account is associated with any qualifying merchant programs in the database. In particular, the request at 303 may include identifying information for the merchant with whom the shopper has begun the checkout process and the transaction processing system backend 350 may attempt to retrieve membership information associated with both an account associated with the received user identifying information and the merchant. The results of the query are provided to the transaction processing system frontend 340 at 304. If the shopper has a corresponding membership, then the benefits and discounts attendant to that membership can be applied to the order as described herein.

In the example illustrated in FIG. 3, the transaction processing system backend 350 has determined that the shopper 330 does not have an existing membership associated with the applicable merchant. Therefore, after receiving information indicating as much at 304, the transaction processing system frontend 340 displays a user interface including interactive elements to continue the checkout process. One of the interface elements can include an element through which a user can register for a membership. At 305, the shopper 330 selects the interface element to register for a membership with the merchant (or an affiliated group of merchant including the merchant). Upon receiving this request, the transaction processing system frontend, at 306, saves the current registration state, including all information received from the shopper 330 and may cause a user interface into which the shopper 330 can begin to enter information necessary for processing the checkout request.

Before proceeding, the transaction processing system can determine whether the shopper 330 has an existing account with transaction processing system. The existing account can include payment information, shipping details, and shipping preferences which may streamline the checkout process by reducing the number of user interfaces that must be displayed to the shopper, reducing the number of updates and amount of resources used by the transaction processing system frontend 340 and transaction processing system backend 350.

If no existing shopper account is detected, the process 300 proceeds to 307. At 307, the transaction processing system frontend 340 may add any applicable discounts associated with the membership to the order by requesting the transaction processing system backend 350 to update the shopper's shopping cart or order information. Upon receiving the request, at 308, the transaction processing system backend 350 may communicate with a plugin 360 associated with the transaction processing system on a merchant system of the merchant to inform the merchant system that the shopper 330 will be using a non-shipping discount on this order. The plugin 360 may be used to manage discounts and expectations of the merchant system. At 309, the plugin 360 may obtain confirmation from the merchant system and may transmit the confirmation and updated cart information, including for example updated pricing information, to the transaction processing system backend 350. The updated pricing information may also be reflective of additional benefits awarded by the merchant due to membership in the membership program. At 310, the transaction processing system backend 350 may cause the transaction processing system frontend 340 to update to show the updated order information, such as through an appropriate shopping cart or order information user interface (discussed herein).

At 311, upon receiving the updated order information, the shopper 330 can select an interactive element in the user interface presented by the transaction processing system frontend 340 that accepts the updated order information. The shopper 330 can provide shipping details, such as a shipping address for the order and a selection of shipping options for the order. The transaction processing system frontend 340 receives the entered information and, at 312, communicates the entered information to the transaction processing system backend 350. The transaction processing system backend 350 can then determine if, based on the entered shipping details and the shoppers membership in the membership program, the shopper 330 is eligible for discounted shipping. The transaction processing system backend 350 may perform this check itself, or may communicate with the transaction processing system plugin 360 to determine eligibility (e.g., through confirmation with the merchant system). At 313, the transaction processing system backend 350 may communicate with the transaction processing system platform plugin 360 to update the order information with the shipping details including any applicable shipping discounts or shipping-related benefits. The transaction processing system platform plugin 360 may confirm the shipping discounts and/or benefits with the merchant system. In some embodiments, the transaction processing system platform plugin may apply additional benefits, not added by the transaction processing system backend 350. At 314, the transaction processing system platform plugin 360 sends updated order information to the transaction processing system backend 350, which updates its records of the order information and, at 315, causes the transaction processing system frontend 340 to update according to the updated order information. This may include the transaction processing system fronted 340 providing a new or updated user interface showing the applied shipping discount or other benefit.

If, in alternative, an existing transaction processing system account associated with the shopper 330 is determine, the process may instead proceed to 316. At 316, the transaction processing system frontend 340 may communicate with the transaction processing system backend 350 to apply all relevant discounts simultaneously. The transaction processing system backend 350 may use the retrieve account information associated with the shopper 330 to calculate shipping charges and other related extra charges associated with the order. The transaction processing system backend 350 may also retrieve the shopper's preferred shipping options and other shipping details and apply the discounts associated with those shipping options. At 317, the transaction processing system backend 350 may communicate with the transaction processing system platform plugin 360 to apply both the non-shipping discounts associated with the order as well as apply the shipping-related discounts associated with the shopper's preferred shipping options. The transaction processing system platform plugin 360 may confirm the non-shipping discounts, shipping discounts, and/or benefits with the merchant system. In some embodiments, the transaction processing system platform plugin 360 may apply additional benefits, not added by the transaction processing system backend 350. At 318, the transaction processing system platform plugin 360 sends updated order information to the transaction processing system backend 350, which updates its records of the order information and, at 319, causes the transaction processing system frontend 340 to update according to the updated order information. This may include the transaction processing system fronted 340 providing a new or updated user interface showing the applied discounts, including shipping discounts, or other benefits.

The transaction processing system frontend 340 may now provide an order confirmation user interface to the shopper 330. The order confirmation user interface may include all relevant order information, such as the items included (including, potentially charges for the enrollment into the membership), shipping options and address, any applied discounts, etc. The shopper 330 may be requested to enter payment information, or, if the shopper has an existing account with the transaction processing system, may be asked to simply confirm a preferred payment method. At 320, the shopper provides the requested information to the transaction processing system frontend 340 and may, for example, select an interactive user interface element corresponding to a confirmation and request to place the order. As discussed herein, where the membership is associated with a fee, the shopper may be asked to approve an additional charge to cover enrollment in the membership the current transaction. This may be added to the shopper's shopping cart or order information. At 321, after receiving the confirmation and request, the transaction processing system frontend 340 may place a request to a specified endpoint of the transaction processing system backend 350 for authorization payment for orders. For example, the transaction processing system frontend 340 may call a provided application programming interface with requested parameters corresponding to the order details (such as an order token generated and stored by the transaction processing system backend 350 during one or more of the above-described step) and payment information. At 322, upon the transaction processing system backend 350 validating the payment information, the transaction processing system backend 350 may update the database associated with the transaction processing system to associated the membership program information with the account of the user, such as by storing a reference to the membership program in associated with the user identifying information for the shopper.

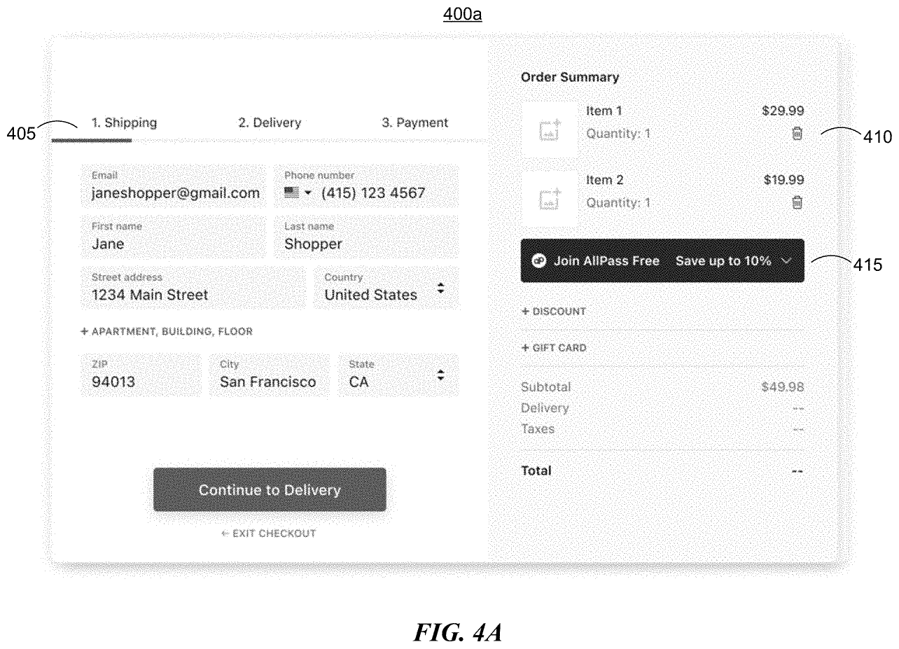

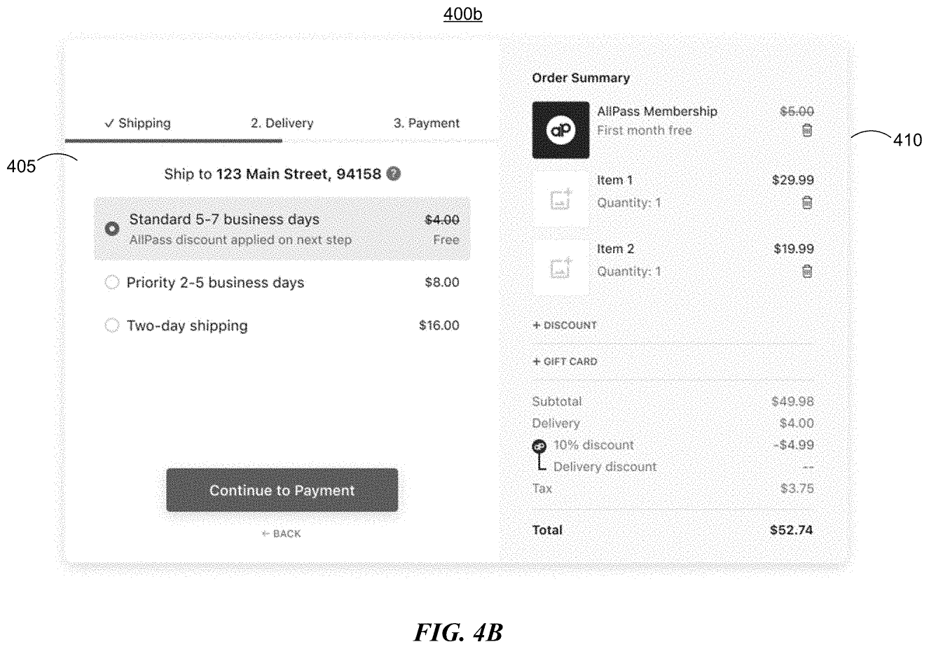

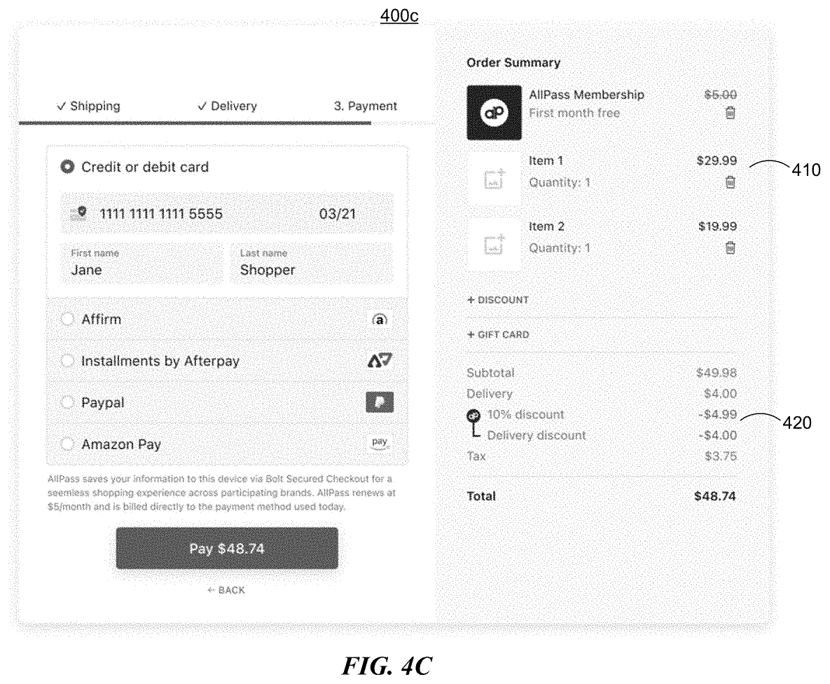

FIGS. 4A-4C illustrate example user interfaces that may be presented to and used by shoppers using the transaction processing system. In particular, FIGS. 4A-4C illustrate example interfaces that may be used by shoppers before they sign up for a membership program through the membership platform.

FIG. 4A illustrates a first user interface 400a that corresponds to a checkout screen provided to a shopper of a merchant using the transaction processing system. The user interface 400a includes a section 405 showing the shipping information and other information necessary for placing an order. Section 410 shows a summary of the shoppers current order, including items to be purchased. The user interface 400a further includes an interactive element 415 to encourage the shopper to join a membership program which the merchant participates in. As illustrated, the interactive element indicates that there is no cost to join to the membership program and indicates that one benefit is to save up to 10% on transactions.

FIG. 4B illustrates a second user interface 400b that may correspond to a checkout screen provided to the shopper after they have elected to join the membership program (e.g., by selecting the interactive element 415). Section 410 has been updated to show that the user has joined the membership program and that the normal monthly price is $5.00 which has been waived. Section 405 has been updated to allow the shopper to select shipping options. In particular, section 405 indicates to the shopper that selecting the standard shipping option will be free as a result of membership in the membership program.

FIG. 4C illustrates a third user interface 400c that may correspond to a checkout screen provided to the shopper after they have elected to join the membership program (e.g., by selecting the interactive element 415). Section 410 has been updated to show that the user has joined the membership program and that the normal monthly price is $5.00 which has been waived. Section 410, pertaining to the order accounting, indicates to the shopper that at 10% discount and delivery discount have been applied to the order as a result of the membership program. The shopper can place the order using the pay now interactive interface element.

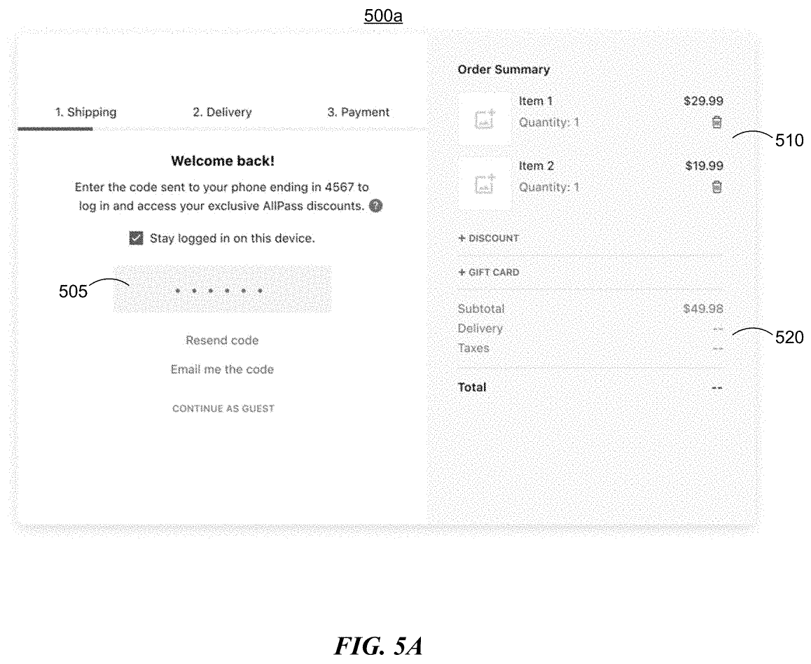

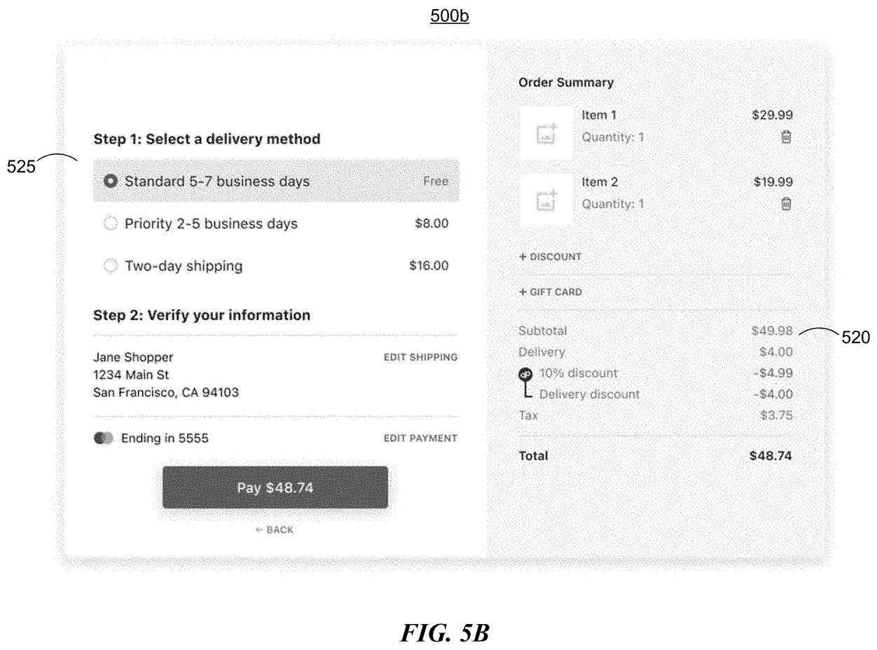

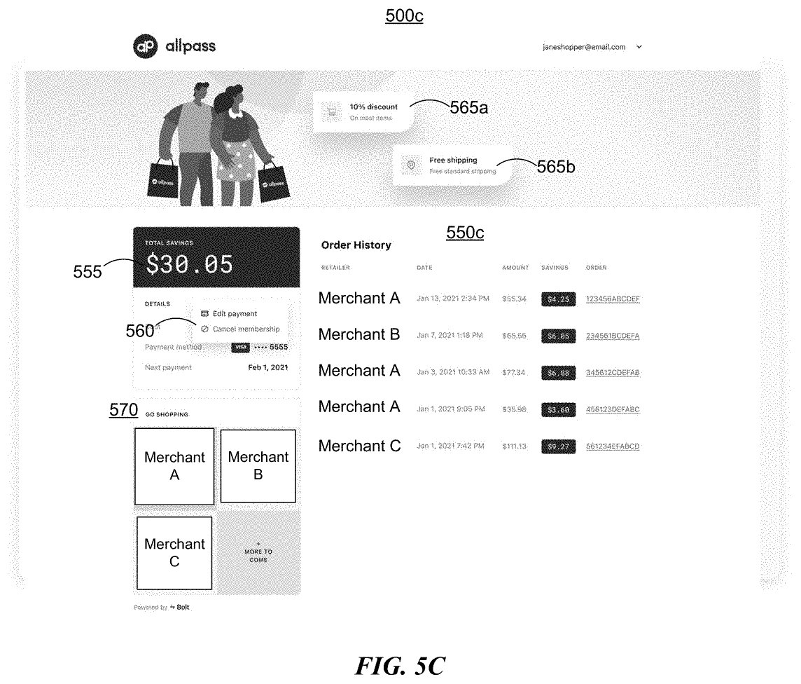

FIGS. 5A-5C illustrate example user interfaces that may be presented to and used by shoppers using the transaction processing system. In particular, FIGS. 5A-5C illustrate example interfaces that may be used by shoppers with existing account associated with the membership program.

FIG. 5A illustrates a user interface 500a that includes a checkout screen that may be shown to the shopper. The checkout screen also includes a portion that may correspond to an account authentication user interface 505, through which the shopper can choose to log in to an existing account (e.g., account associated with the merchant or the transaction processing system). As with user interface 400a, the user interface 500a of FIG. 5A includes a section 510 showing the products that are a part of the current order and a section 520 showing the order subtotal.

FIG. 5B illustrates a user interface 500b that includes the checkout screen after the user has successfully completed the account authentication check. In particular, the transaction processing system has validated the shopper's account and identified that the shopper has an existing membership in a membership program provide by the merchant associated with the order. Therefore, the section 520 has been updated to include the discounts applied to the order as a benefit of their membership in the program. Additionally, because the shopper has stored payment information with the transaction processing system, their payment and shipping details (e.g., address) have been pre-populated in the section 525, expediting checkout.

FIG. 5C illustrates a user interface 500c that includes a dashboard for the shopper to manage their membership in a membership program. User interface 500c includes a section 550 listing the shopper's order history with various merchants that includes an identification of the merchant in the order, a date of the order, the amount of the order, an amount saved through the membership program, and a link to the order. Note that, even though orders are listed for three different merchants, the dashboard serves as a central location to view this location, rather than requiring the shopper to go to three different merchant website. User interface element 555 shows the shopper their total savings through their membership. Element 560 include links to allow the user to modify the terms of their membership and/or cancel their membership. Elements 565a and 565b list some of the benefits available to the customer through the membership program. Section 570 includes interactive elements corresponding to links to merchant websites of the merchants participating in the membership program. This both lists the applicable merchants and provides an easy access to the merchants to the shopper.

Particular embodiments disclosed herein may be implemented using one or more example architectures described herein. Underlying foundational concepts and terms of art relied upon may relate to one or more of the following:

A transaction processing system platform of which the “Bolt Platform” is an example, can consist of four conceptual parts. The frontend that serves both the main consumer checkout flow as well as internal and external dashboards and administrative tools. The core services that power the checkout flow as well as fraud detection and payments. Bolt is architected as a set of independent services which communicate to each other via HyperText Transfer Protocol Representational State Transfer (“HTTP REST”) or AMAZON Web Services Simple Queue Service (“AWS SQS”) messages. The Bolt Application Programming Interface (“Bolt API”), which is the primary means by which merchant systems interface with Bolt, exposed to the outside world via HTTPS REST. Plugins, which are deployed to merchant systems and which connect these systems with the Bolt API.

Other foundational concepts and terms of art may relate to one or more of the following:
Processor integrations to automate chargeback handling (syncing, representment)
A regression model to predict chance of winning a representment. From the regression model the system may derive the expected value.
A classification model to recommend action items to the merchant. Example action items including fighting chargebacks or not or what is the most valuable evidence.
Merchant integration to potentially generate evidence automatically. Evidence may include:
   AVS results
   CVV results
   Billing/shipping addresses
   Historical orders
   Shipment receipt
   Tracking details
   Third party data on the user

In all example embodiments described herein, appropriate options, features, and system components may be provided to enable collection, storing, transmission, information security measures (e.g., encryption, authentication/authorization mechanisms), anonymization, pseudonymization, isolation, and aggregation of information in compliance with applicable laws, regulations, and rules. In all example embodiments described herein, appropriate options, features, and system components may be provided to enable protection of privacy for a specific individual, including by way of example and not limitation, generating a report regarding what personal information is being or has been collected and how it is being or will be used, enabling deletion or erasure of any personal information collected, and/or enabling control over the purpose for which any personal information collected is used.

The frontend of the Bolt Platform is stored in a monorepo. It consists of the following sub-components:
“Connect.js”—renders the Bolt checkout button and bootstrap iframe for checkout
“checkout”—which is the user-facing component for checkout experience
“Merchant”—which is the merchant facing dashboard
“Admin”—which is the internal dashboard used by risk analysts, merchant success, and engineering

The core services and the APIs are stored in a monorepo. Examples of services include:
“API”13 which is the set of APIs that power the checkout flow
“adminapi”—which is the set of APIs that power the admin dashboard.
“apihooks”—which sends webhook messages to merchant's shopping platforms
“AsyncJobs”—which is the job framework to handle long-running asynchronous operations
“Notifier”—which sends notifications such as emails and short message service (“SMS”) messages
“Imageproxy”—which is a lightweight proxy to serve images

Backend services may be written in go (with some machine-learning (“ML”) logic in python used for risk modeling). Frontend components may be written in React/Typescript. Data may be stored in Postgres, hosted by a relational database service (RDS). Another database used for state management may be Redis.

“Tokenizer” is a completely separate service, available in a serverless way to handle card tokenization. Tokenizer may be maintained completely separate do payment card industry security standards. Tokenizer may be made available in a serverless way, for example, through a service such as AMAZON Lambda. The tokenizer may be implemented in Typescript, powered by a postgres DB. All of the tokenizer infrastructure may be maintained by a separate provider account, with access restricted to a few people.

Below are more details about key services and technology components.

| Service/Component | Purpose/Functionality | Frameworks/Languages |
|---|---|---|
| API | All communication with 3p services, | Golang |
| | front end code, business logic | |
| Connect.js and | Connect.js used for rendering checkout | React |
| iFrame | button, entry point for merchants | Typescript |
| | IFrame is how we host checkout form, | Webpack |
| | secure communication with API | |
| checkout frontend | Components used to collect user | React |
| | information during checkout | Redux |
| | | Webpack |
| | | Typescript |
| Notifier | Microservice for enqueueing and | Golang |
| | sending email and SMS notifications to | SQS |
| | consumers and merchants. | MAILGUN |
| | | TWILIO |
| Account.js and | Used for BigCommerce account | React |
| iFrame | dashboard—also uses an Iframe to | Redux |
| | display data | Webpack |
| | | Typescript |
| Shopping Dashboard | Features added to above Account.js | React |
| | | Redux |
| | | Webpack |
| | | Typescript |
| Asynchronous jobs | Heavy lifting of job logic to perform | Golang |
| | tasks like funding, risk review, etc | Redis |
| | | Machinery |
| Apihooks (i.e | Microservice for enqueueing and | Golang |
| Webhooks) | sending webhook events to merchant | SQS |
| | platforms. | |
| Payment jobs | Scheduler for Asyncjobs framework | Golang |
| | | Machinery |
| | | Redis |
| Search | service to index transactions for | Golang |
| | merchant dashboard | Elastic Search |
| Tokenizer | PCI compliant serverless lambda to store | Node.js |
| | credit card information. Used to proxy | AWS Lambda |
| | information to 3rd parties | AWS Key Management |
| | | Service (“KWS”) |
| | | AWS RDS |
| Gatekeeper/A/B | Experimentation and feature rollout | Typescript |
| experimentation | platform | AWS Simple Storage |
| | | Service (“S3”) |
| | | AWS CLOUDFRONT |
| Sleet | Provides a standardized wrapper for | Golang |
| | implementing many payment processor | |
| | gateways. | |
| Risk pipeline | Modeling training and model serving | Golang |
| | | Python |
| | | SAGEMAKER |
| Track.js and iFrame | Used to track customer behavior when | Typescript |
| | they land on merchant’s page. Used for | React |
| | risk signals | |
| Ledger | Double write bookkeeping service for | Golang |
| | funds. Tracks money movements | |
| | through the system | |
| Chargeback | Automated system to pull chargeback | Golang |
| management | information from various payment | React |
| | processors and display to merchants in | Typescript |
| | the merchant dashboard chargeback | |
| | portal | |
| Reporting and | Reports pulled from Vantiv and | Golang |
| Reconciliation | asyncjob with the ledger to ensure fee | Asyncjobs |
| | collection | AWS S3 |
| Merchant Dashboard | Centralized dashboard for all actions and | GraphQL |
| | reporting related to a merchant’s | React |
| | management of their Bolt system. | Typescript |
| Admin Dashboard | Centralized dashboard for all internal | GraphQL |
| | actions related to managing Bolt | React |
| | merchants. | JavaScript |
| Admin API | API for actions done by Bolt internal | Goland |
| | employees (onboarding merchants, | GraphQL |
| | turning on features) and majority of use | |
| | is for risk review | |

Integration with ecommerce platforms is supported in two ways. First, directly via the API. Second, with plugins deployed to the host instance.

Database: Data is stored in highly available postgres databases backed by AWS RDS. Databases can scale their components within available limits for disk (up to 16 TB), CPU/ram/network (db.xle.32×large which is 64 cpu and 3,904 TB RAM).

Messaging: Both Consumer and Merchant-facing components do messaging through our Notifier Service.

Data Access: Services communicate via REST. GraphQL is used pervasively for all non-external endpoints.

Data Warehouse: A cloud data warehousing service may service as the main data warehouse that stores the refined data. AMAZON ELASTIC MAPREDUCE may be used for extract, transform, load (“ETL”) workflows and general analysis of the raw data. AWS Step functions, triggered by a cloud watch event, and AWS Lambda may be used to run the ETL workflows. Results may be loaded into the data warehouse. Code such as ETL scripts may be separately managed. Data consumers (e.g. analysts who look at checkout events) use may use plugins to run queries.

Hosting model: The systems may run on highly available containerized backend services backed, for example, by DOCKER and KUBERNETES on AWS. The backend services may be scaled up/down with zero downtime. Infrastructure for serving the frontend code is highly available and backed by AWS. Frontend serving automatically scales with traffic load.

Logging: Frontend (Bolt checkout modal) logs are sent to an error monitoring and reporting tool. All backend applications (e.g., api, paymentjobs, asyncjobs, notifier, etc.) and infrastructure logs (e.g., kubernetes, AWS) are sent to a cloud monitoring platform. Logs may be archived for long-term storage.

Monitoring: High and low level monitors exist to notify engineers of issues. Monitors are replicated to non-production environments to ensure issues can be caught before they make it to production. Monitors are managed in code to ensure consistency and to track changes. Overall application service-level agreements (SLAs) are measured, and lower level monitoring of metrics and logs may be performed using a cloud monitoring platform.

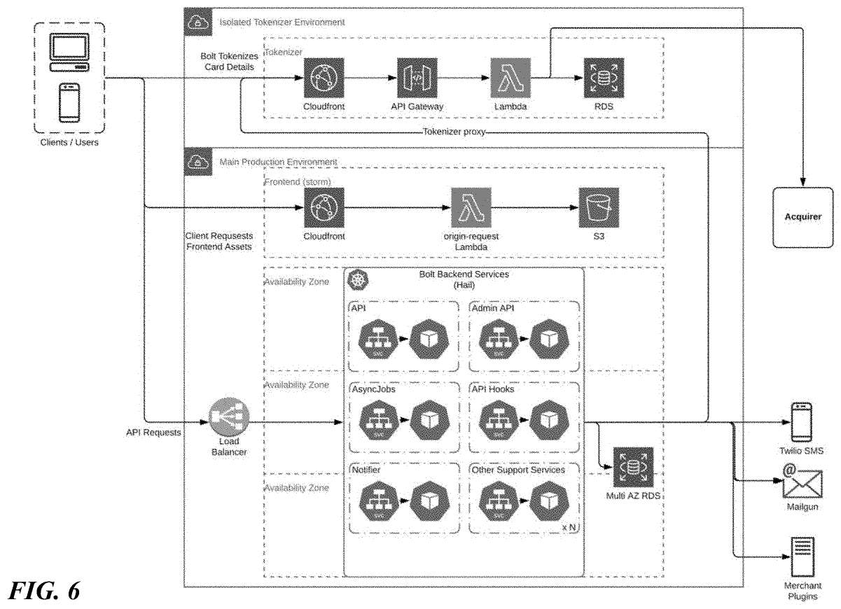

FIG. 6 highlights the physical architecture of the platform.

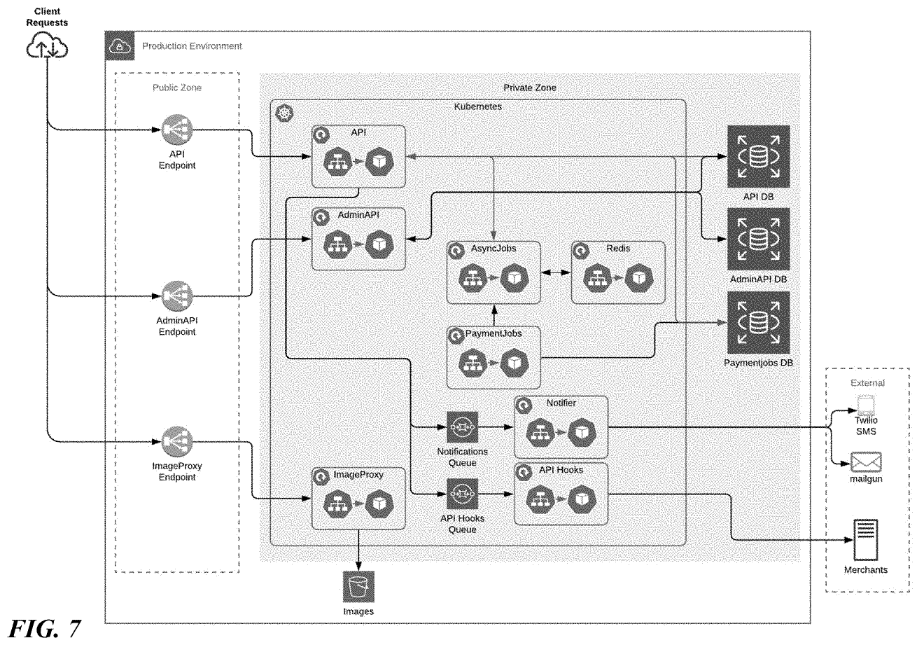

FIG. 7 shows an alternate visualization of the platform, focusing on backend services.

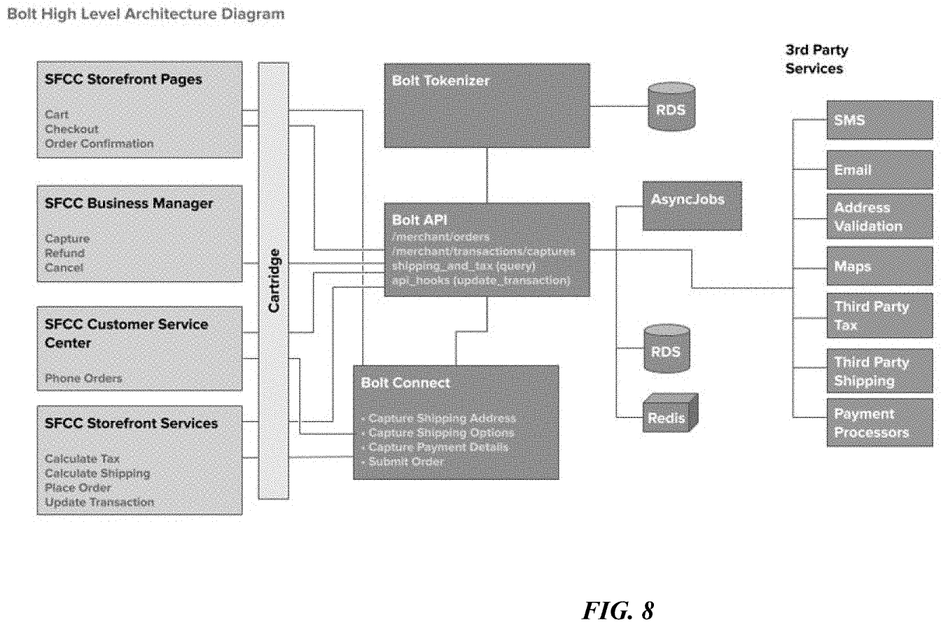

FIG. 8 is helpful in understanding how the platform connects with a third party ecommerce platform.

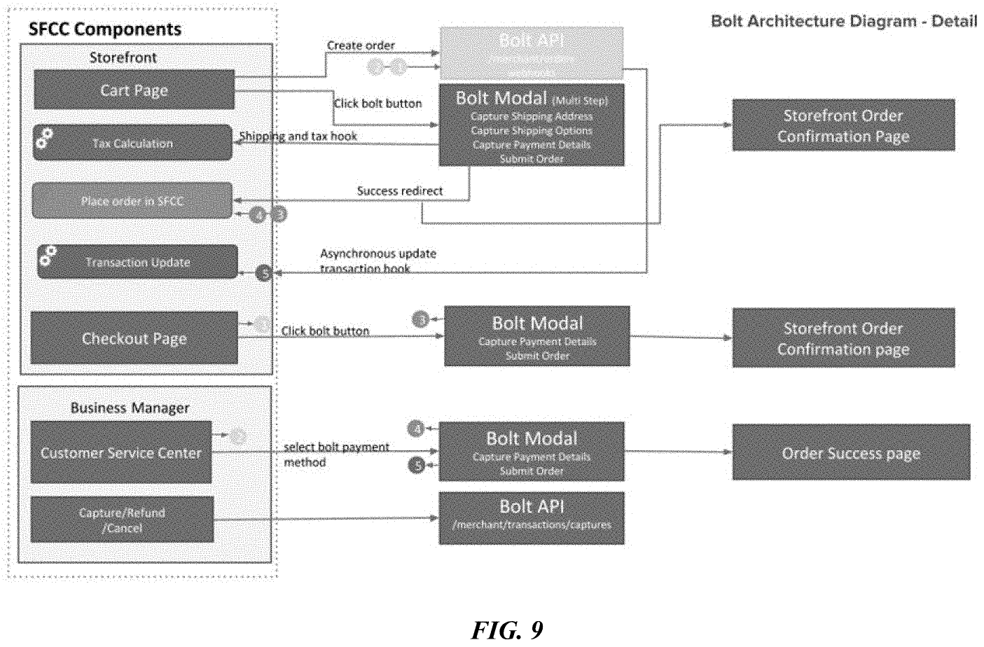

FIG. 9 dives a layer deeper and illustrates the information flows between the platform and a third party platform.

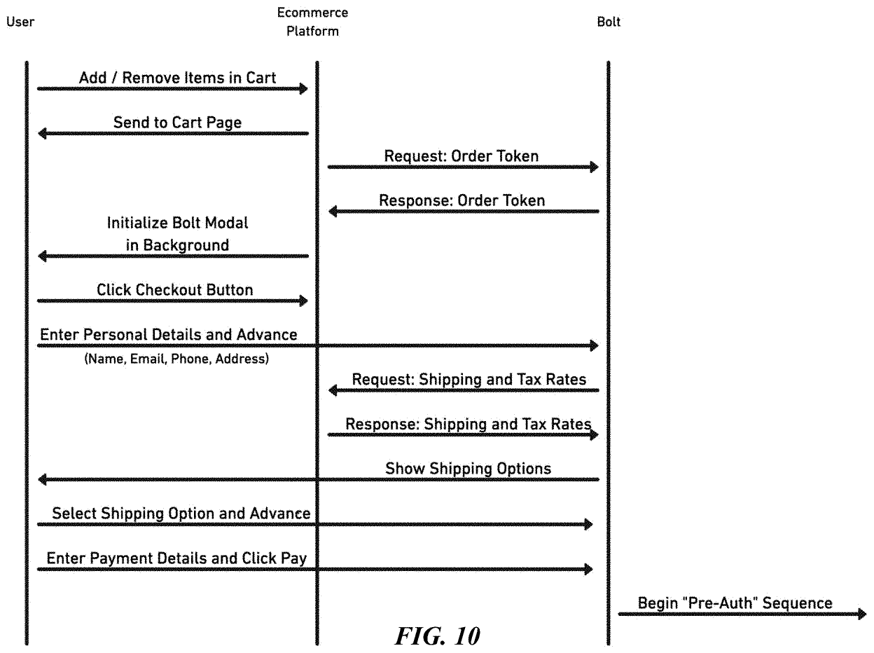

FIG. 10 illustrates the lifecycle of a purchase order.

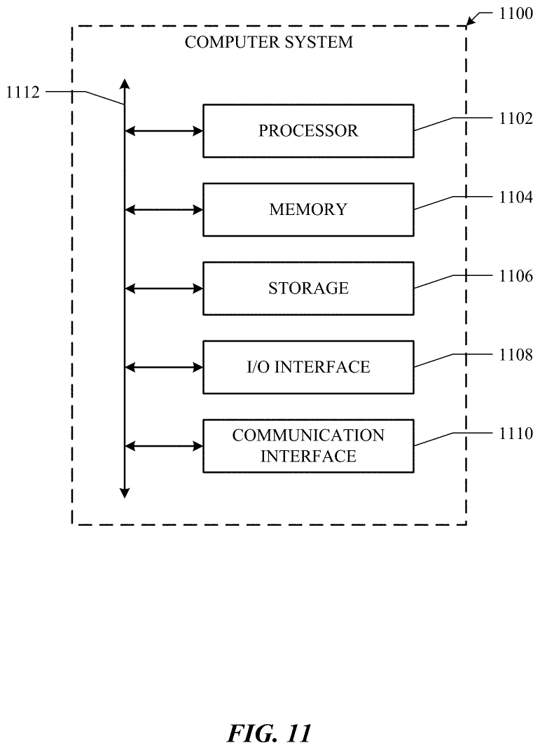

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, any reference herein to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, by a transaction processing system, an order request from a buyer, the order request comprising identifying information for the buyer and corresponding to a request for a transaction between the buyer and a seller;
identifying, by the transaction processing system, membership program information for the buyer corresponding to a membership program associated with the seller and order preference information for the buyer based on querying a database associated with the transaction processing system using the identifying information for the buyer;
causing, by the transaction processing system, an order placement user interface to be presented to the buyer, the order placement user interface comprising data stored in the membership program information;
receiving, by the transaction processing system, an order placement request corresponding to the order request via the order placement user interface; and
updating the membership program information for the user based on the order placement request.

2. The method of claim 1, wherein the order preference information comprises payment information and shipping information stored by the transaction processing system on behalf of the buyer.

3. The method of claim 1, wherein the order request is received from a seller computing device.

4. The method of claim 1, wherein the order request is received from a user device associated with the buyer.

5. The method of claim 1, further comprising:
determining, by the transaction processing system and based on the membership program information for the buyer, that the buyer does not have a pre-existing relationship with the seller.

6. The method of claim 5, where updating the membership program information for the user based on the order placement request comprises enrolling the buyer in the membership program.

7. The method of claim 1, wherein the membership program is associated with an affiliated group of sellers comprising the seller, and wherein the membership program information is based on a pre-existing relationship with the affiliated group of sellers.

8. The method of claim 1, wherein the membership program is associated with an affiliated group of sellers comprising the seller, and wherein the membership program information is based on a pre-existing relationship with another seller of the affiliated group of sellers.

9. The method of claim 8, further comprising generating the membership program information for the buyer by:
accessing a record of transactions conducted by the buyer with the seller;
accessing a record of transactions conducted by the buyer with the other seller of the affiliated group of sellers using the transaction processing system; and
merging the record of transactions conducted by the buyer with the seller and the record of transactions conducted by the buyer with the other seller of the affiliated group of sellers.

10. The method of claim 1, further comprising:
determining, by the transaction processing system, that the buyer is eligible for a discount to be applied to the transaction between the buyer and the seller by:
accessing a database associated with the seller based on the membership program information for the buyer;
retrieving a set of discounts associated with the membership program available for the buyer from the database associated with the seller, wherein one or more discounts of the set of discounts are associated with a restriction; and
determining that the transaction between the buyer and the seller satisfies the restriction associated with a first discount of the set of discounts based on at least the membership program information for the buyer; and
applying, by the transaction processing system, the first discount to the transaction.

11. The method of claim 10, wherein the discount is applied responsive to a selection of the discount by the buyer.

12. The method of claim 10, further comprising, after applying the discount to the transaction, updating the database associated with the seller to indicate that the buyer has used the first discount.

13. The method of claim 1, further comprising:
identifying one or more membership benefits corresponding to the membership program;
determining that the buyer is eligible for a first membership benefit of the one or more membership benefits based on at least the membership program information for the buyer; and
applying the first membership benefit to the transaction between the buyer and the seller.

14. The method of claim 13, wherein the record of transactions conducted by the buyer with the seller is received from a merchant system associated with the seller.

15. The method of claim 1, wherein:
the membership program comprises a plurality of benefit tiers, each tier being associated with a set of membership benefits;
wherein the membership program information for the buyer identifies a first benefit tier of the plurality of benefit tiers; and
wherein updating the membership program information for the user based on the order placement request comprises modifying the membership program information for the buyer to identify a second benefit tier of the plurality of benefit tiers.

16. A transaction processing system comprising:
one or more processors; and
one or more computer-readable non-transitory storage media coupled to one or more of the processors and comprising instructions operable when executed by one or more of the processors to cause the system to perform operations comprising:
receiving, by a transaction processing system, an order request from a buyer, the order request comprising identifying information for the buyer and corresponding to a request for a transaction between the buyer and a seller;
identifying, by the transaction processing system, membership program information for the buyer corresponding to a membership program associated with the seller and order preference information for the buyer based on querying a database associated with the transaction processing system using the identifying information for the buyer;
causing, by the transaction processing system, an order placement user interface to be presented to the buyer, the order placement user interface comprising data stored in the membership program information;
receiving, by the transaction processing system, an order placement request corresponding to the order request via the order placement user interface; and
updating the membership program information for the user based on the order placement request.

17. A method comprising:
receiving, by a transaction processing system, a request from a seller to create a membership program for the seller, wherein the seller has conducted a plurality of transactions with a plurality of buyers, respectively, using the transaction processing system;
accessing, by the transaction processing system, a record of the plurality of transactions in a database associated with the transaction processing system;
accessing, by the transaction processing system, a user account record for each buyer of the plurality of buyers from the database associated with the transaction processing system, wherein the user account record for each buyer comprises a respective user identifier for the buyer;
creating, by the transaction processing system, membership program information for each buyer of the plurality of buyers using the record of the plurality of transactions; and
storing, by the transaction processing system in the database associated with the transaction processing system, the membership program information for each buyer of the plurality of buyers in association with a respective user identifier for the buyer and the user account record for the buyer.

18. The method of claim 17, wherein the request identifies one or more other sellers to associate with the membership program for the seller, the method further comprising:
accessing a respective record of transactions conducted by the one or more other sellers using the transaction processing system; and
updating the membership program information of the plurality of buyers based on the respective record of transactions conducted by the one or more other sellers.

19. The method of claim 17, further comprising:
receiving a checkout request for a transaction between the seller and a buyer, the checkout request comprising a user identifier for the buyer;
retrieving the membership program information for the buyer from the database associated with the transaction processing system based on the user identifier; and
updating the membership program information for the buyer based on the checkout request for the transaction.

20. The method of claim 17, wherein prior to requesting to create the membership program, the seller has a pre-existing membership program, not associated with the transaction processing system; and
wherein the seller discontinues the pre-existing membership program after sending the request to create the membership program.
